(19) United States
(12) Patent Application Publication
(10) Pub. No.: US 2022/0230094 A1
(43) Pub. Date: Jul. 21, 2022

(54) MULTI-TENANT MODEL EVALUATION

(71) Applicant: Citrix Systems, Inc., Fort Lauderdale, FL (US)

(72) Inventor: George Panitsas, Patras (GR)

(21) Appl. No.: 17/163,991

(22) Filed: Feb. 1, 2021

Related U.S. Application Data
(63) Continuation of application No. PCT/GR2021/000006, filed on Jan. 21, 2021.

(51) Int. Cl. G06N 20/00; G06F 11/34; G06K 9/62

(52) U.S. Cl. CPC G06N 20/00; G06K 9/6227; G06F 11/3447; G06F 11/3428

(57) ABSTRACT

A method may include generating, by a computing system, a first tenant-specific model for a first tenant. The method may further include generating, by the computing system, first metrics for the first tenant-specific model. The method may also include generating, by the computing system, a second tenant-specific model for the first tenant. The method may additionally include generating, by the computing system, second metrics for the second tenant-specific model. Moreover, the method may include comparing, by the computing system, the first metrics and the second metrics to select one of the first tenant-specific model and the second tenant-specific model as a first selected tenant-specific model for the first tenant.

### CROSS-REFERENCE TO RELATED APPLICATIONS

This application is a continuation of and claims the benefit under 35 U.S.C. § 120 and 35 U.S.C. § 365(c) to International Application PCT/GR2021/000006, entitled MULTI-TENANT MODEL EVALUATION, with an international filing date of Jan. 21, 2021, the entire contents of which are incorporated herein by reference for all purposes.

### BACKGROUND

Models such as machine learning models may be designed and trained to process data to create useful outputs. For example, machine learning models may be used for image or speech recognition. Image data for a set of photographs may be used as training data to train a machine learning model to recognize a particular feature in a photograph. The machine learning model may then process new image data which may be representative of new photographs and determine whether or not the particular feature is present in each photograph. Thus, a machine learning model may be trained and may learn from data such that it can process new data to provide a useful output.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may include generating, by a computing system, a first tenant-specific model for a first tenant. The method may further include generating, by the computing system, first metrics for the first tenant-specific model. The method may also include generating, by the computing system, a second tenant-specific model for the first tenant. The method may additionally include generating, by the computing system, second metrics for the second tenant-specific model. Moreover, the method may include comparing, by the computing system, the first metrics and the second metrics to select one of the first tenant-specific model and the second tenant-specific model as a first selected tenant-specific model for the first tenant.

In some disclosed embodiments, a computing system may include at least one processor, and at least one computer-readable medium encoded with instructions which, when executed by the at least one processor, cause the computing system to generate a first tenant-specific model for a first tenant. The instructions may further cause the computing system to generate first metrics for the first tenant-specific model. The instructions may also cause the computing system to generate a second tenant-specific model for the first tenant. The instructions may additionally cause the computing system to generate second metrics for the second tenant-specific model. Moreover, the instructions may cause the computing system to compare the first metrics and the second metrics to select one of the first tenant-specific model and the second tenant-specific model as a first selected tenant-specific model for the first tenant.

In some disclosed embodiments, a method may include training, by a computing system, first and second tenant-specific machine learning (ML) models for a first tenant while training, by the computing system, third and fourth tenant-specific ML models for a second tenant, the training of the first, second, third, and fourth tenant-specific ML models based on a first solution. The method may further include testing, by the computing system, the first tenant-specific ML model to produce first metrics, the second tenant-specific ML model to produce second metrics, the third tenant-specific ML model to produce third metrics, and the fourth tenant-specific ML model to produce fourth metrics. The method may also include comparing, by the computing system, the first metrics and the second metrics to select one of the first tenant-specific ML model and the second tenant-specific ML model as a first selected tenant-specific ML model for the first tenant, and comparing, by the computing system the third metrics and the fourth metrics to select one of the third tenant-specific ML model and the fourth tenant-specific ML model as a second selected tenant-specific ML model. The method may additionally include processing, by the computing system, first data with the first selected tenant-specific model to produce a first output, and processing, by the computing system, second data with the second selected tenant specific model to produce a second output.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1 is a diagram showing example components of a first illustrative multi-tenant model evaluation system in accordance with some aspects of the present disclosure;

FIG. 2 is a diagram of a network environment in which some components of multi-tenant model evaluation systems disclosed herein may be deployed;

FIG. 3 is a diagram of an example computing system that may be used to implement one or more components of the network environment shown in FIG. 2;

FIG. 4 is a diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource management system, such as that shown in FIG. 5C, is employed;

FIG. 6 shows an example multi-tenant model evaluation process involving example operations in accordance various aspects of the disclosure;

FIG. 7 shows a sequence diagram illustrating an example workflow involving the example multi-tenant model evaluation systems shown in FIGS. 1 and 8; and

FIG. 8 is a diagram showing example components of a second illustrative multi-tenant model evaluation system in accordance with some aspects of the present disclosure.

### DETAILED DESCRIPTION

For purposes of reading the description of the various embodiments below, the following descriptions of the sections of the specification and their respective contents may be helpful:

Section A provides an introduction to example embodiments of multi-tenant model evaluation systems configured in accordance with some aspects of the present disclosure;

Section B describes a network environment which may be useful for practicing embodiments described herein;

Section C describes a computing system which may be useful for practicing embodiments described herein;

Section D describes a cloud computing environment which may be useful for practicing embodiments described herein;

Section E describes embodiments of systems and methods for managing and streamlining access by clients to a variety of resources;

Section F provides a more detailed description of example embodiments of the multi-tenant model evaluation systems introduced above in Section A; and

Section G describes example implementations of methods, systems/devices, and computer-readable media in accordance with the present disclosure.

### A. Introduction to Illustrative Embodiments of Multi-Tenant Model Evaluation Systems

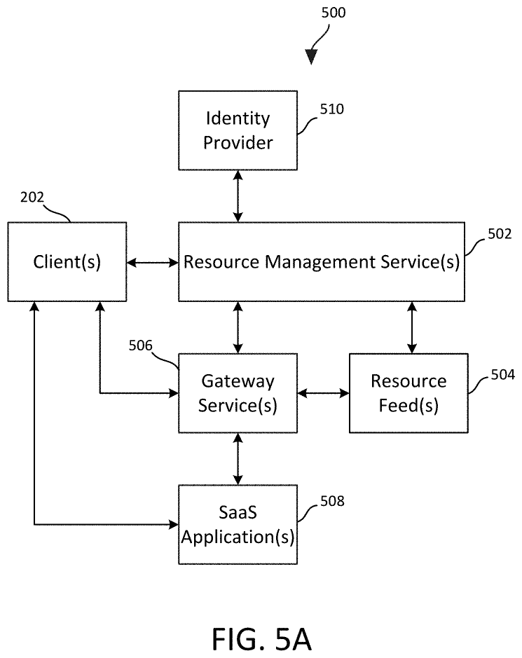

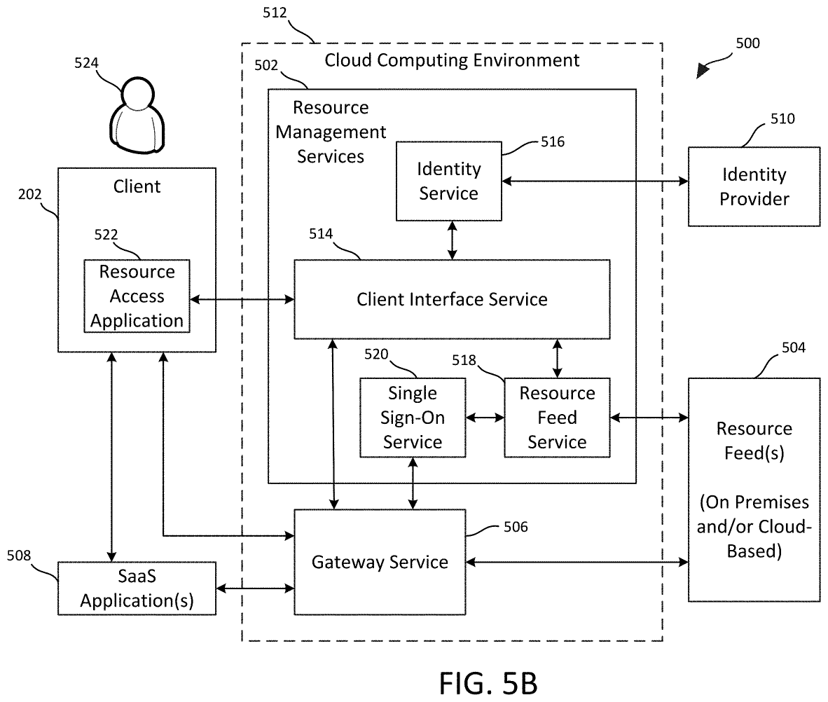

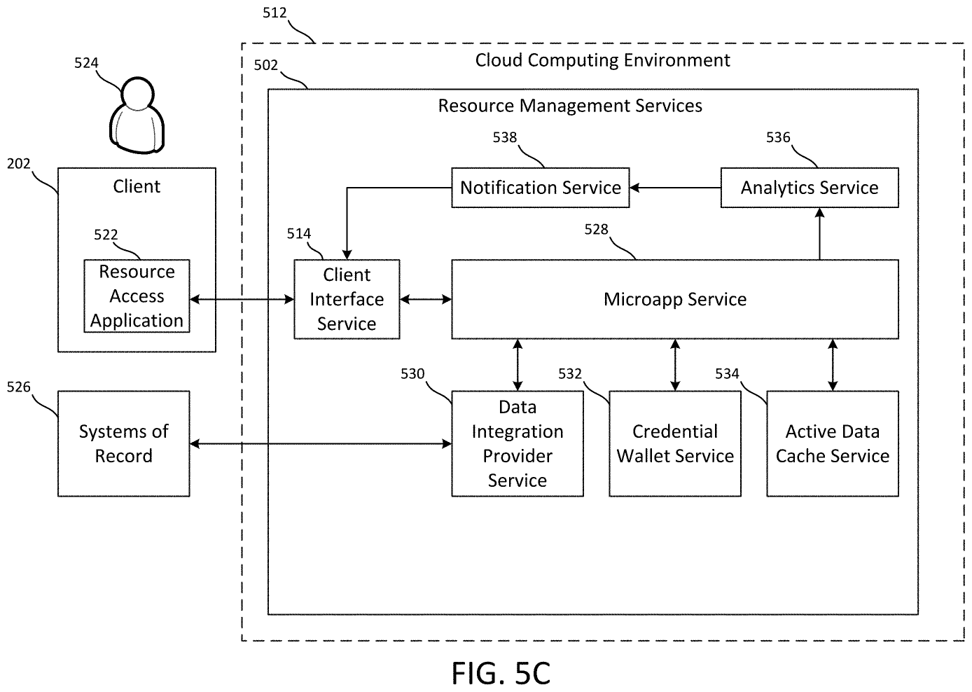

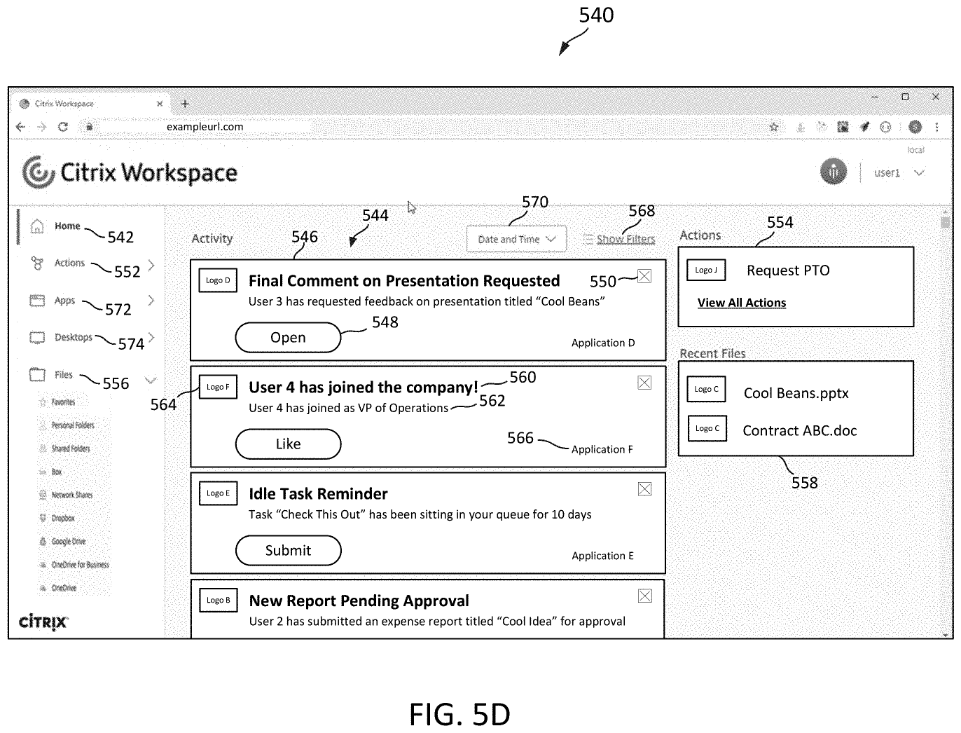

As discussed above, a machine learning model may be trained and may learn from data such that it can process new data to provide a useful output. For example, an analytics service (e.g., the analytics service 536 as shown in FIG. 5C) or platform may include machine learning models that allow for machine learning-based solutions, which may provide value to various products and services. Various products and services included in the Citrix Workspace™ family of products offered by Citrix Systems, Inc., of Fort Lauderdale, Fla., include capabilities that include or may be improved with machine learning-based solutions. Such machine-learning based solutions may, for example, allow for or assist with the implementation of a variety of features including, but not limited to: scoring activity feed (e.g., the activity feed 544 as shown in FIG. 5D) notifications (e.g., the notifications 546 as shown in FIG. 5D), identifying abnormal user behavior, identifying indicators of risk, improving file recommendations in a file-search service, and other intelligent workspace features.

Machine learning models may be implemented via a machine learning model pipeline which may include a training stage, an evaluation stage, and an inference stage. A typical machine learning model pipeline may train, evaluate, and serve one model at a time, which may be sufficient for many analytics platforms and solutions. For example, a machine learning model may be trained with one data set and served to the inference stage where a new data set is processed with the model to produce an output.

A multi-tenant solution may be designed to benefit more than one tenant, where the solution trains separate models for respective tenants or groups of tenants. Multi-tenancy may refer to an architecture where a single instance of software or a software application (and supporting hardware and data) serves multiple tenants. A tenant may generally be an entity or organization with common access to the software or software application. Each tenant may have data separated from or inaccessible to the other tenants that share the software or software application. For example, Software-as-a-Service (SaaS) applications may be provided by multi-tenant systems.

The example of scoring activity feed notifications (e.g., the notifications 546 as shown in FIG. 5D) may be illustrative of the benefits of a multi-tenant machine learning model solution. As described below in Section E, an intelligent workspace (e.g., the multi-resource access system 500 described in connection with FIGS. 5A-D) may include a service that logs into applications on behalf of a user (e.g., via application programming interfaces (APIs)) and gathers data about events or status for the user. The gathered data may be fed to an analytics service (e.g., the analytics service 536 as shown in FIG. 5C) which may create targeted scored notifications to send the user based on the events or status of the user's applications. A notification service (e.g., the notification service 538 as shown in FIG. 5C) may then push the notifications to a resource access application (e.g., the resource access application 522 shown in FIGS. 5B and 5C) on a client device operated by the user, where the notifications may appear as individual notifications about the applications for the user.

The notifications (e.g., the notifications 546 as shown in FIG. 5D) may indicate actions for the user to take, approvals for the user to give, information about the user's meetings or events (e.g., reminders), etc. A notification scoring solution may be a machine learning solution that collects, as a training data set, many or all of the notifications for users across respective tenants or groups of tenants and collects data about the behavior of users as they interact with the notifications. This data may show which notifications are most interesting or important for the user. The intelligent workspace may benefit from prioritizing and sorting the notifications based on specific criteria (e.g., based on urgency and what is most interesting or important to the user as indicated by the data). Based on the type of notification, the action taken by the user, and the history of the user, an algorithm such as a machine learning model may score the notifications.

The analytics service (e.g., the analytics service 536 as shown in FIG. 5C) may receive the notification data and process the data with machine learning models at an interval (e.g., hourly, daily, nightly, weekly, etc.). Because the intelligent workspace may be a multi-tenant service, there may be a model for each tenant or even each user of each tenant. The data may be representative of tenant or user behavior and there may be scoring logic for each tenant or each user. The machine learning model may be stored in a model repository and when notification data is received by the analytics service, the notification data may be streamed to a model inference stage. The model inference stage may load the trained machine learning model trained for the tenant or the user. The notification data may be input to the trained machine learning model which may produce as output a score for the notification (e.g., the notifications 546 as shown in FIG. 5D). The score may help the notification service (e.g., the notification service 538 as shown in FIG. 5C) appropriately order the notification for the user. As each tenant or each user may have its own trained machine learning model or models and its own notification data, there may be a large number of models for multi-tenant machine learning solutions.

As another example, an anomaly detection solution for security may benefit from multi-tenant machine learning models where analytics may be based on abnormal user behavior detection. User behavior telemetry may include user activity such as a usual number of logins, usual user locations, volume of uploaded/downloaded data, etc. A typical user for a particular tenant may download certain amounts of data, log in from certain locations or log in a certain number of times a day, etc. A model may be trained on this type of data across respective tenants or groups of tenants and the trained models may be stored in a repository. During an inference stage, new user data may be processed with a model trained for a particular tenant or user, and possible deviations from normal behavior might be identified and raise alerts.

Thus, for a multi-tenant machine learning model solution, multiple models may need to be trained across respective tenants or groups of tenants, with the respective tenants or groups of tenants having their own data sets. Multiple models may be produced per tenant or even per user. The inference stage may also be performed on a per tenant basis and instead of loading one model for the inference, one or more models per tenant may need to be implemented, again, with respective tenants or groups of tenants having their own data sets. Accordingly, multi-tenant machine learning model platforms may benefit from training, evaluating, and serving multiple models in parallel.

A machine learning model for multi-tenant solutions may produce a trained model for respective tenants or groups of tenants during the training stage. In such situations, a machine learning model pipeline that can train, evaluate, and serve multiple models for multiple tenants in parallel may be beneficial. This may also be true for machine learning platform solutions designed for multiple users, multiple devices, or particular solutions such as load balancing for delivery of applications or services.

Multi-tenancy may introduce challenges in the evaluation and serving stages of a machine learning pipeline. A training session for a multi-tenancy solution may generate a large number of trained models (e.g., on a per-tenant or per-entity basis) over the course of a time period (e.g., hourly, daily, nightly, weekly, etc.). While model repositories may support relatively large numbers of trained models, model evaluation and serving solutions may not be scaled to handle multi-tenancy machine learning solutions due to the large number of trained models produced. Trained model evaluation may typically be performed manually by an administrator of the system or a data scientist who may decide which of the trained models are advanced to the serving stage and which are not. Typical machine learning model pipelines may support only individual model service (e.g., Representational State Transfer (REST)-API services dedicated to a single trained model).

In this regard, the inventors have recognized and appreciated that due to the large numbers of trained models involved in multi-tenancy machine learning solutions, the administrator or data scientist may not have the capacity to perform trained model evaluation, and there may be too many models to handle in the inference stage. The inventors have thus recognized and appreciated a need to improve the scalability of multi-tenant machine learning solutions such that multi-tenancy can be efficiently handled in the machine learning pipeline while preserving usability and control for the administrator or data scientist (e.g., providing the ability to define trained model evaluation logic/policy and providing visibility and traceability).

Using the techniques and features described in the present disclosure for multi-tenant model evaluation, improved scalability for handling multi-tenancy aspects of machine learning model training and evaluation may be achieved through implementing a machine learning model pipeline that trains and serves a large number of tenant-specific machine learning models. By implementing a logic/policy-based model evaluation service that enables the administrator or data scientist to define and deploy model evaluation policies, the large number of tenant-specific machine learning models may be automatically evaluated, selected, and/or promoted through the pipeline to the inference stage. Further, using the techniques and features described in the present disclosure, AB testing, which may be a useful machine learning model testing technique and may be difficult to implement in the inference stage of multi-tenant solutions, may be scaled and implemented in a multi-tenant machine learning model pipeline.

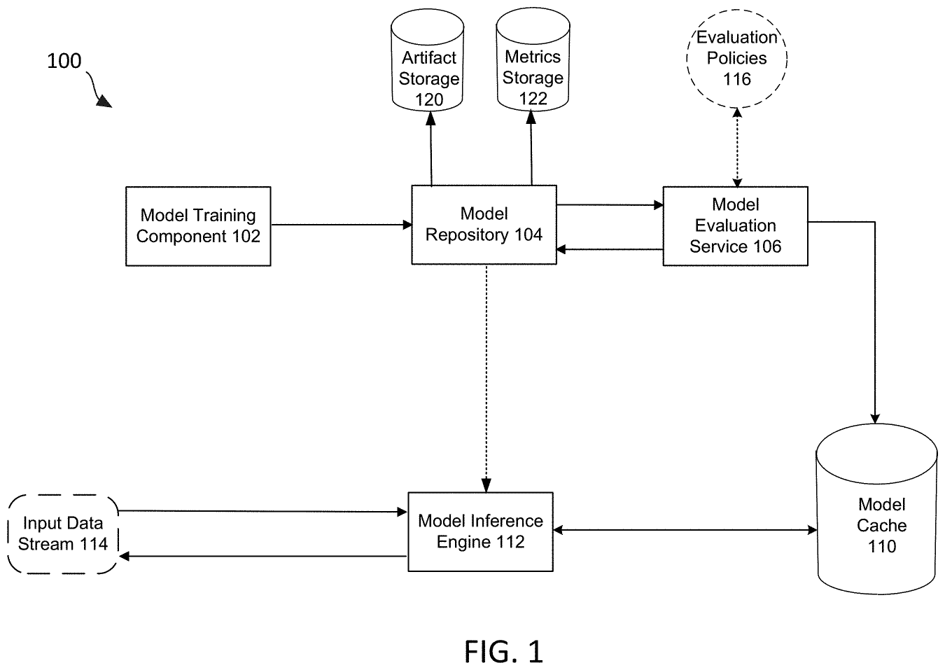

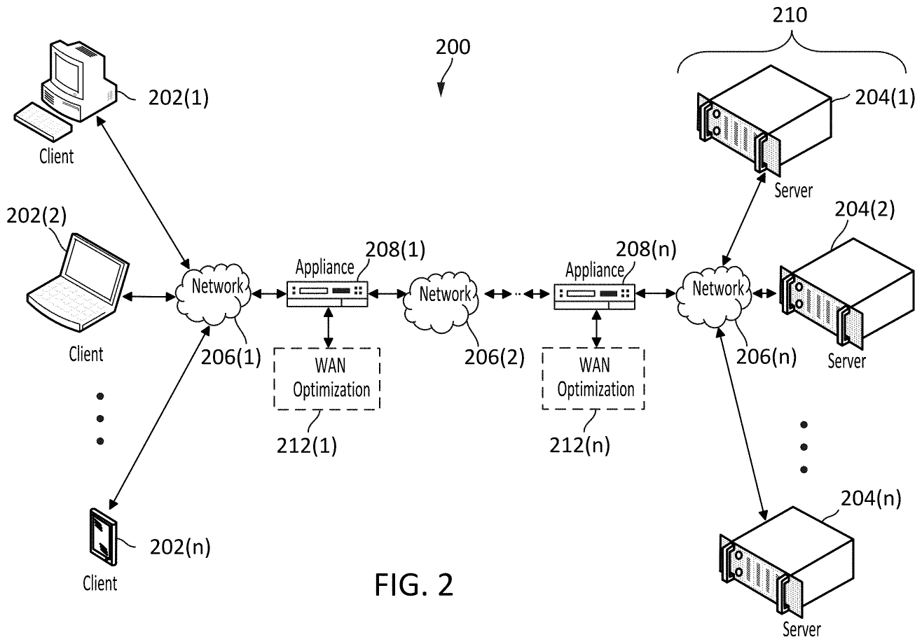

Referring now to FIG. 1, example components of a first illustrative multi-tenant model evaluation system in accordance with aspects of the present disclosure are shown. A system 100 may be implemented with one or more computing systems (e.g., one or more servers). The term “computing system” as used herein may refer to one or more computers or servers with which the system 100 may be implemented. Referring also to FIG. 2, the system 100 may, for example, be implemented with one or more of servers 204(1)-204(n). In some implementations, the system 100 may be an analytics platform or service (e.g., the analytics service 536 as shown in FIG. 5C) such as a multi-tenant machine learning model platform and may include a multi-tenant machine learning model pipeline as described herein.

As shown in FIG. 1, the system 100 may be a multi-tenant model evaluation system and may include a model training component 102, a model repository 104, a model evaluation service 106, a model cache 110, and a model inference engine 112. The model training component 102 may train machine learning models with training data in a training stage. The training data may include data from respective tenants or groups of tenants served by a platform (e.g., SaaS platform) such as an intelligent workspace platform. The training component 102 may generate or produce one or more models (e.g., machine learning models) per tenant based on the training data. Many of the tenant models or each of the tenant models may be trained in parallel, simultaneously, or otherwise at the same time or in overlapping time periods, which may result in a large number of trained models. The training component 102 may also produce metrics (e.g., evaluation metrics) on which the trained models can be evaluated.

The training component 102 may pass the trained models (e.g., trained machine learning models) and the evaluation metrics to be saved in the model repository 104. The model repository 104 may store the trained models and the evaluation metrics. In some embodiments, the model repository 104 may be a service in communication with an artifact storage 120 and a metrics storage 122. An artifact may be a serialized binary object that represents a trained model. The artifact storage 120 may be persistent storage that stores the artifacts that represent the models. The metrics storage 122 may be a database that stores the evaluation metrics.

The model evaluation service 106 may evaluate the trained models and determine which of the trained models performs well enough to be used in the inference stage. As discussed above, because the models may be trained on a per tenant basis, there may be a large number of trained models to evaluate, and there may be different strategies or policies for evaluating which models to promote. However, using the techniques and features described in the present disclosure, model evaluations and determination of model performance may be automated and may be based on configurable policies or logic. For example, as shown in FIG. 1, the model evaluation service 106 may receive model evaluation policies 116. The model evaluation policies 116 may be determined or configured by an administrator or data scientist and may be input to the model evaluation service 106.

Rather than the administrator or data scientist manually analyzing the evaluation metrics for each model, the model evaluation service 106 may automatically analyze the evaluation metrics for each model based on the evaluation policies 116. If a trained model performs well enough based on the evaluation metrics and the evaluation policies 116, it may be promoted and published to the inference stage. If the trained model does not perform well enough, the previous model may be continued to be used. In this way, the system 100 may create a continuous loop of producing trained models, evaluating the trained models, and promoting the best models to the inference stage.

The model evaluation service 106 may send promoted models to a model cache 110. The model cache 110 may be storage that is closer to or more accessible by the model inference engine 112 than the model repository 104. When a new model is advanced through the model pipeline by the model evaluation service 106 and promoted, a previous model may be removed from the model cache 110 and replaced by the promoted model. The promoted model may be published to the inference stage.

The model inference engine 112 may access the promoted models from the model cache 110. The model inference engine 112 may accept as input a stream of events or client requests which may include a payload that acts as a serving dataset. The model inference engine 112 may receive the payload or dataset (e.g., new user data) from input data stream 114. The trained model that should be used to process the dataset may be determined from the input stream or client request and may be loaded from the model cache 110. In some situations, the model inference engine 112 may load the trained model from the model repository 104. For example, a particular model may not be available from the model cache 110. A status of the model as determined by the model evaluation service 106 (described in further detail below) may also indicate which trained model is to be loaded. In some embodiments, trained models can be pre-fetched for efficiency.

The model inference engine 112 may process the dataset with the trained model and return a value (e.g., a score, or other useful data such as a detected anomaly). The returned value may be beneficial for the tenants or users. For example, as discussed above in the case of activity feed notifications (e.g., the notifications 546 as shown in FIG. 5D), the returned value may be a score that may help the notification service (e.g., the notification service 538 as shown in FIG. 5C) appropriately order notifications for the user. Typical model inference engines may load one trained model and produce an output. Using the techniques and features described in the present disclosure, by training models for multiple tenants in parallel (e.g., by the model training component 102) and evaluating the trained models in parallel (e.g., by the model evaluation service 106), the model inference engine 112 may load and process data with a large number of trained models. Further, the model inference engine 112 may gain efficiency by integrating with the model evaluation service 106 for the inference stage (e.g., via the model repository 104). The model inference engine 112 may be an inference service for a given solution and may be scaled as needed for multi-tenant solutions. The inference service may load trained models on a per-tenant basis (e.g., from the model cache 110 or the model repository 104) and serve the trained models.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of an organization.

### C. Computing Environment

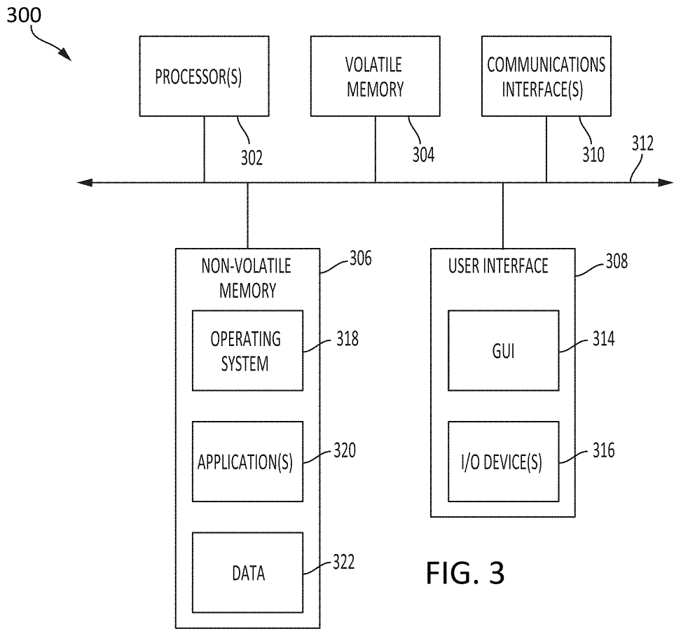

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Cloud Computing Environment

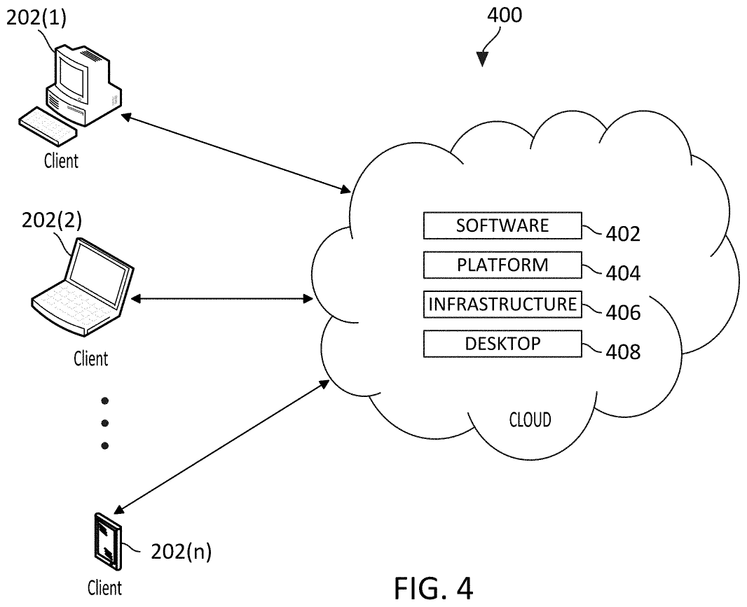

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., username and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource application is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and XML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one or more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D), a “relevancy” mode (not illustrated) may be selected (e.g., using the element 570) in which the notifications may be sorted based on relevancy scores assigned to them by the analytics service 536, and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user-interface element 552 or by selecting a desired action from a list 554 of recently and/or commonly used microapp actions. As shown, additional resources may also be accessed through the screen 540 by clicking on or otherwise selecting one or more other user interface elements that may be presented on the screen. For example, in some embodiments, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files. Further, in some embodiments, one or more applications may additionally or alternatively be accessible (e.g., via a Citrix Virtual Apps and Desktops™ service) by clicking on or otherwise selecting an “apps” user-interface element 572 to reveal a list of accessible applications or by selecting a desired application from a list (not shown in FIG. 5D but similar to the list 558) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user-interface element 574 to reveal a list of accessible desktops or by or by selecting a desired desktop from a list (not shown in FIG. 5D but similar to the list 558) of recently and/or commonly used desktops.

The activity feed shown in FIG. 5D provides significant benefits, as it allows a user to respond to application-specific events generated by disparate systems of record without needing to navigate to, launch, and interface with multiple different native applications.

### F. Detailed Description of Example Embodiments of Multi-Tenant Model Evaluation Systems and Processes

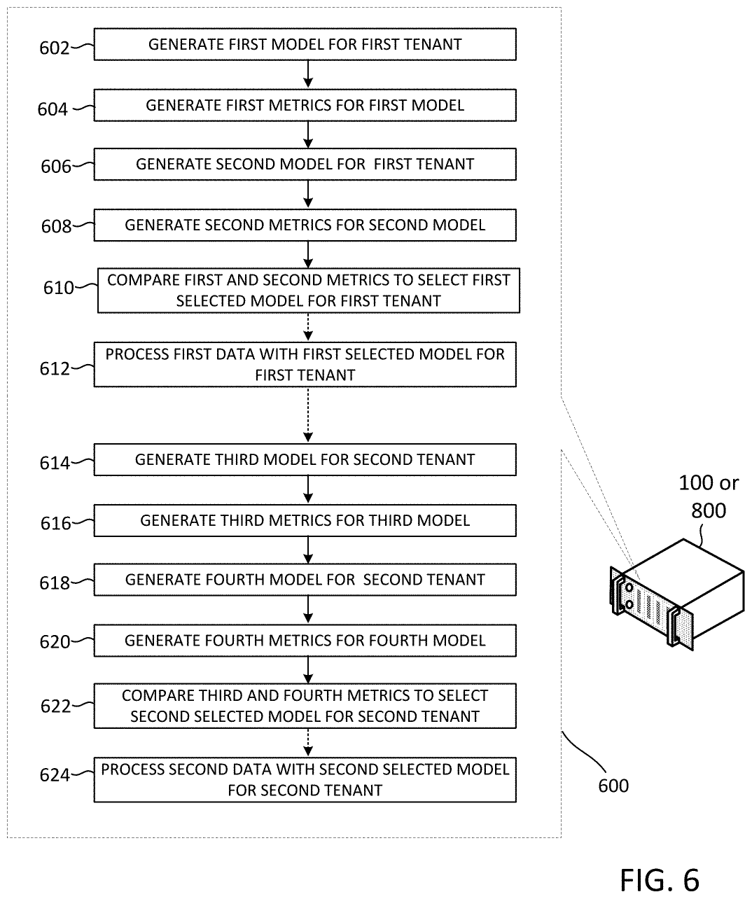

Referring now to FIG. 6, an example multi-tenant model evaluation process 600 involving example operations in accordance with some aspects of the present disclosure is shown. As shown, in some implementations, the process 600 may include generating (602) a first tenant-specific model for a first tenant (e.g., via the model training component 102). The process 600 may also include generating (604) first metrics (e.g., evaluation metrics) for the first tenant-specific model (e.g., via the model training component 102). The process 600 may further include generating (606) a second-tenant specific model for the first tenant (e.g., via the model training component 102). The process 600 may additionally include generating (608) second metrics (e.g., evaluation metrics) for the second tenant-specific model (e.g., via the model training component 102). Moreover, the process 600 may include comparing (610) the first metrics and the second metrics to select one of the first tenant-specific model and the second tenant-specific model as a first selected tenant-specific model for the first tenant (e.g., via the model evaluation service 106 and the evaluation policies 116). In some implementations, the process 600 may include processing (612) first data (e.g., new user data) with the first selected tenant-specific model to produce a first output (e.g., via model inference engine 112).

The first and second tenant specific models may be viewed as two versions of the same model produced by training over a different training dataset. In an example, the two versions of the model may have been trained on consecutive days or at different times. Further, in an example, the first and second tenant specific models may have been produced from different algorithms (e.g., algorithm A, algorithm B).

Further, in some implementations, the process 600 may include generating (614), a third tenant-specific model for a second tenant (e.g., via the model training component 102). The process 600 may further include generating (616) third metrics for the third tenant-specific model (e.g., via the model training component 102). The process 600 may also include generating (618) a fourth-tenant specific model for the second tenant (e.g., via the model training component 102). The process 600 may additionally include generating (620) fourth metrics for the fourth tenant-specific model (e.g., via the model training component 102). Further, the process 600 may include comparing (622) the third metrics and the fourth metrics to select one of the third tenant-specific model and the fourth tenant-specific model as a second selected tenant-specific model for the second tenant (e.g., via the model evaluation service 106 and the evaluation policies 116). In some implementations, the process 600 may include processing (624) second data with the second selected tenant-specific model to produce a second output (e.g., via model inference engine 112).

It should be noted that using the techniques and features described in the present disclosure for multi-tenant model evaluation, any of the operations 602-612 may be performed in parallel, simultaneously, or during overlapping time periods with regard to the operations 614-624. In other words, any of the operations 606-612 may be performed while any of the operations 614-624 are being performed. Thus, a machine learning model pipeline may be scaled to handle trained models across multiple tenants or users by training, evaluating, and serving trained models in parallel, simultaneously, or during overlapping time periods.

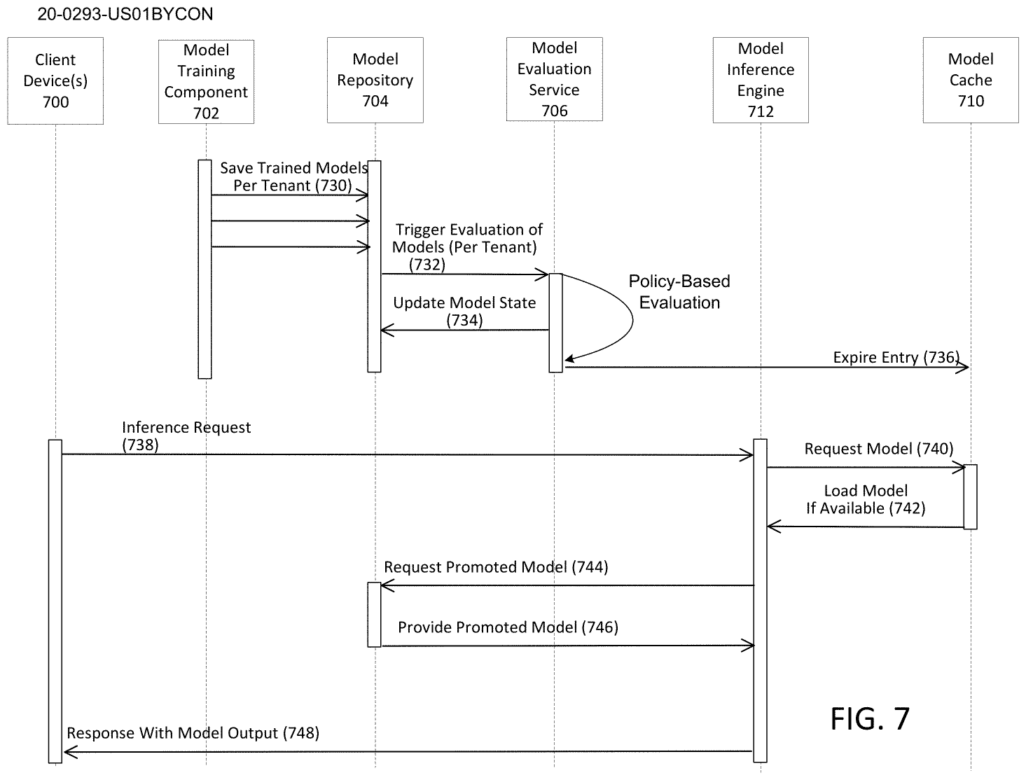

Referring now to FIG. 7, a sequence diagram illustrating an example workflow involving the example multi-tenant model evaluation systems shown in FIG. 1 is shown. The sequence diagram shows client device(s) 700, a model training component 702, a model repository 704, a model evaluation service 706, a model inference engine 712, and a model cache 710. The model training component 702, the model repository 704, the model evaluation service 706, the model inference engine 712, and the model cache 710 may be similar to the model training component 102, the model repository 104, the model evaluation service 106, the model inference engine 112, and the model cache 110, respectively, described above.

As shown in the sequence diagram, the model training component 702 may produce multiple trained models per tenant which may be saved (730) in parallel in the model repository 704. This may trigger evaluation (732) of the trained models (e.g., when a new model is produced) at scale and in parallel by the model evaluation service 706. The policy-based evaluation (e.g., based on the evaluation policies 116) may produce an update that is stored (734) back at the model repository 704. The update or output may be a flag indicating that the model passed the evaluation and the model may be promoted to production to the inference stage based on the defined policy (e.g., the evaluation policy 116). With the update, the model evaluation service 706 may expire an entry (736) in the model cache 710 (e.g., a previous model may be removed from the cache).

An inference request (738) for a trained model may be sent (e.g., with an indication from a client device 700) to the model inference engine 712. At the inference stage, the inference request (740) may be processed using the trained model. The trained model may be loaded (742) from the model cache 710 if it has been cached. If the model cache 710 does not have the trained model, then a newer and better model may have been promoted and the model inference engine 712 may request (744) the promoted model from the model repository 704. The model repository 704 may provide (746) the promoted model to the model inference engine 712. The model inference engine 712 may process client data with the promoted model to produce an output which may then be provided (748) to the client device 700.

As discussed above in Section A, multi-tenant model evaluation systems in accordance with the present disclosure may provide several advantages, including scalability. These advantages may be realized in part from automated model evaluation as described above. For example, the model evaluation service 106 of FIG. 1 may automatically analyze the evaluation metrics for each model based on the evaluation policies and may support parallel evaluation of models. In other words, the model evaluation service 106 may evaluate trained models for multiple tenants in parallel, simultaneously, or during overlapping time periods.

In some embodiments, the model evaluation service 106 may be triggered upon a new model registration in the model repository 104. The model evaluation service 106 may load the trained model and the applicable evaluation policies based on the solution. Upon evaluation of the trained model, the status of the model may be updated to, for example, one of the following: production (e.g., the model performs well enough based on the evaluation policy and has been promoted to production) or archived (e.g., the model does not perform well enough based on the evaluation policy and should not be used). In some embodiments, the model status may be updated to testing A or testing B (or version A or version B) for AB testing during the inference stage, which will be described below.

The evaluation metrics may be generated in the model training stage during model training or testing. The evaluation metrics available may be different for supervised learning (e.g., using labeled datasets) as compared to unsupervised learning (e.g., using unlabeled datasets). A model developer may define one or more evaluation metrics that may be calculated and published upon each model training, including on a per tenant basis for multi-tenant model training. The model evaluation service 106 may load historical values for the evaluation metrics and apply defined evaluation logic or policy (as discussed in more detail below).

Example evaluation metrics are provided below for illustrative purposes only as other evaluation metrics not provided are with the scope of the present disclosure. For supervised learning with classification-based models (e.g., Naïve Bayes, Random Forest, and Decision Tree algorithms), evaluation metrics may include, but are not limited to: F1 score, accuracy score, recall score, and receiver operating characteristic-area under curve (ROC-AUC) score. For supervised learning with regression-based models (e.g., Linear Regression and Support Vector Machine algorithms), evaluation metrics may include, but are not limited to: root mean squared error and mean absolute error. For unsupervised learning with data clustering-based models (e.g., K-Means and Spectral Clustering algorithms), evaluation metrics may include, but are not limited to: adjusted Rand score and silhouette coefficient.

The evaluation policies 116 may be defined by the developer as part of configuration of the model evaluation service 106. In some embodiments, the evaluation policies 116 may be deployed in the form or an evaluation service artifact and may be different based on each solution. Model evaluation (and promotion) policies 116 may include, but are not limited to: promoting the newest model, maximizing an evaluation metric, and/or minimizing an evaluation metric. Evaluation logic may be customized to consider combinations of metrics and weights may be assigned to the metrics and a model evaluation score may be generated. For example, in some embodiments, the model evaluation (and promotion) policies 116 may be implemented via custom logic (e.g., via Python or other programming languages). The evaluation policies 116 may be implemented with the system 100 to allow the model evaluation service 106 to be scalable, such that many trained tenant-specific models may be evaluated in parallel, simultaneously, or during overlapping time periods.

While the model evaluation service 106 may be automated to evaluate trained models based on evaluation metrics (e.g., determined during model training/testing) and the evaluation policies 116, different versions of a trained model may provide different outputs and it may be desirable to collect another set of metrics based on processing new data with different versions of the trained model to see which model actually performs better. This may be referred to as A/B testing, which may allow comparing interactions of users with different versions of the model.

For example, it may be desirable to compare models produced by different algorithms (e.g. supervised learning versus unsupervised learning, supervised learning algorithm A versus supervised learning algorithm B, etc.). One algorithm (e.g., algorithm A) may generate models used in production, (e.g., all tenants may see the model output) while the other algorithm (e.g., algorithm B) may be new and under experimentation. The goal of A/B testing may be to measure the impact of the models generated from the new algorithm on a user or tenant. To achieve this, the training stage may be configured to use two different algorithms to train models for one tenant, which may result in two models produced for the same tenant that are trained over the same training dataset (e.g., model A and model B). Model A and Model B may be accompanied by different types of evaluation metrics that are difficult or impossible to directly compare using the model evaluation service. In this situation, the model evaluation service may handle the evaluation of different models produced by algorithms A and B over time (e.g. daily) and confirm that the model inference engine loads the best performing models generated by algorithms A and B.

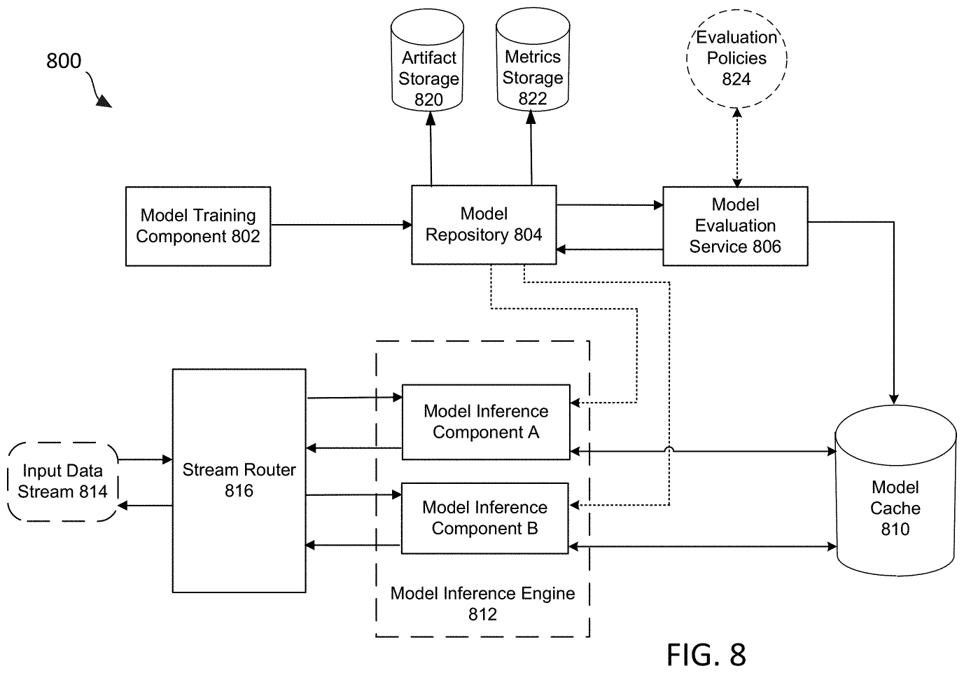

Referring now to FIG. 8, example components of a second illustrative multi-tenant model evaluation system 800 in accordance with aspects of the present disclosure are shown. The system 800 may be implemented with one or more computing systems (e.g., one or more servers) and may be similar, but not identical to, the system 100. For example, the system 800 may provide A/B testing capability, which will be described below. Referring also to FIG. 2, the system 800 may, for example, be implemented with one or more of the servers 204(1)-204(n). In some implementations, the system 800 may be an analytics platform or service (e.g., the analytics service 536 as shown in FIG. 5C) such as a multi-tenant machine learning model platform and may include a multi-tenant machine learning model pipeline as described herein.

The system 800 may be a multi-tenant model evaluation system and may include a model training component 802, a model repository 804, a model evaluation service 806, a model cache 810, a model inference engine 812, an input data stream 814, a stream router 816, an artifact storage 820, and a metrics storage 822. The model training component 802, the model repository 804, the model evaluation service 806, the model cache 810, the model inference engine 812, the artifact storage 820, and the metrics storage 822 of FIG. 8 may be similar to the model training component 102, the model repository 104, the model evaluation service 106, the model cache 110, the input data stream 114, the artifact storage 120, and the metrics storage 122, respectively, of FIG. 1. In the system 800, however, the model inference engine 812 and the stream router 816 may allow for A/B testing capability.

For a given solution, the model inference engine (or service) 812 may be logically split into two engines (or services): a model inference component A and a model inference component B. This is not intended to be a limitation of the present disclosure as two separate model inference engines (or services) may be included: a model inference engine (or service) A and a model inference engine (or service) B, which may provide the same functionality as the model inference component A and the model inference component B, respectively. The model inference component A may handle serving the version A models of the trained models and the model inference component B may handle serving the version B models of the trained models. A stream router 816 may route requests from the input data stream 814. The stream router may split the incoming data stream (e.g., of events or requests) into to two groups (e.g., group A data and group B data) based on configured logic, an algorithm, or randomly, and may feed the group A data into model inference component A and the group B data into model inference component B. Trained tenant models may be loaded dynamically based on payloads and may be cached (e.g., at model cache 810) for efficiency.

The version A models (e.g., those produced by Algorithm A) may be already in production for tenants and the version B models (e.g., those produced by Algorithm B) may be new. It may be beneficial to process new tenant or user data with the version B models to determine if they are better than the version A models (e.g., on a tenant by tenant basis). For example, after a time period (e.g., every night), a new version A model (e.g., produced by algorithm A) and a new version B model (e.g., produced by algorithm B) may be produced. The version A models may be compared by the model evaluation service 806 so that the best performing version is loaded by model inference component A. Further, the version B models may be compared by the model evaluation service 806 so that the best performing version is loaded by the model inference component B. Each tenant or user may provide feedback with new tenant or user data to be processed with the best performing version A model and the best performing version B model in A/B testing. In this way, the scalability of the multi-tenant solution may be extended and implemented with A/B testing.

For example, two different trained models may run in parallel for the same solution. In the activity feed (e.g., the activity feed 544 as shown in FIG. 5D) notification (e.g., the notifications 546 as shown in FIG. 5D) example, one of the models may be used to sort notifications for 90% of users, and the other may sort notifications for the remaining 10%. Even after evaluation by the model evaluation service 106, it may be desirable to obtain new tenant or user data as feedback to determine which version (e.g., the promoted model produced by algorithm A or the promoted model produced by algorithm B) is actually better based on further metrics and to select the better version. The model evaluation service 806 may evaluate a series of version A models and version B models and determine which version A model is best to promote and which version B model is best to promote, but the decision between the promoted version A model and the promoted version B may need to be based on new tenant or user data as feedback because the metrics produced by the version A models may be different than those produced by the version B models during testing and training. In other words the model evaluation service 806 may not be able to compare the version A model and the version B model in the way that A/B testing can. The model evaluation service 806 may handle two streams of trained models and mark the version A models and the version B models. Thus, trained per-tenant models may be produced and evaluated by the model evaluation service 806 and be marked as version A and version B before they reach the inference stage for A/B testing.

Similar evaluation metrics as those used by the model evaluation service 806 may be leveraged for A/B testing and produced during the testing. Example evaluation policies 824 for A/B testing may include, but are not limited to: select the last model, select the newest model, select the model with optimal evaluation metric values, or select the model with the second best optimal evaluation metric values. The evaluation policies 824 may also be implemented via custom logic (e.g., via Python or other programming languages).

While examples have been provided in the present disclosure to illustrate how the advantages of the techniques and features provided may be realized in multi-tenant machine learning models, any solution that is based on training models with multiple sets of training data or evaluating and processing large numbers of models may benefit from the techniques and features described herein.

G. Example Implementations of Methods, Systems, and Computer-Readable Media in Accordance with the Present Disclosure

The following paragraphs (M1) through (M11) describe examples of methods that may be implemented in accordance with the present disclosure.

(M1) A method may be performed that involves generating, by a computing system, a first tenant-specific model for a first tenant; generating, by the computing system, first metrics for the first tenant-specific model; generating, by the computing system, a second tenant-specific model for the first tenant; generating, by the computing system, second metrics for the second tenant-specific model; and comparing, by the computing system, the first metrics and the second metrics to select one of the first tenant-specific model and the second tenant-specific model as a first selected tenant-specific model for the first tenant.

(M2) A method may be performed as described in paragraph (M1), and may further involve processing, by the computing system, first data with the first selected tenant-specific model to produce a first output.

(M3) A method may be performed as described in paragraph (M1) or paragraph (M2), and may further involve generating, by a computing system, a third tenant-specific model for a second tenant; generating, by the computing system, third metrics for the third tenant-specific model; generating, by the computing system, a fourth tenant-specific model for the second tenant; generating, by the computing system, fourth metrics for the fourth tenant-specific model; and comparing, by the computing system, the third metrics and the fourth metrics to select one of the third tenant-specific model and the fourth tenant-specific model as a second selected tenant-specific model for the second tenant.

(M4) A method may be performed as described any of paragraphs (M1) through (M3), and may further involve processing, by the computing system, second data with the second selected tenant-specific model to produce a second output.

(M5) A method may be performed as described any of paragraphs (M1) through (M4), and may further involve comparing, by the computing system, the first metrics and the second metrics while comparing the third metrics and the fourth metrics.

(M6) A method may be performed as described any of paragraphs (M1) through (M5), and may further involve processing, by the computing system, first data with the first selected tenant-specific model to produce a first output while processing second data with the second selected tenant-specific model to produce a second output.

(M7) A method may be performed as described any of paragraphs (M1) through (M6), and may further involve processing, by the computing system, at least a first portion of data with the second selected tenant-specific model for the second tenant to produce fifth metrics, the third tenant-specific model for the second tenant and the fourth tenant-specific model for the second tenant produced based on a first algorithm; processing, by the computing system, at least a second portion of the data with a third selected tenant-specific model for the second tenant to produce sixth metrics, the third selected tenant-specific model selected from a fifth tenant-specific model for the second tenant and a sixth tenant-specific model for the second tenant, the fifth tenant-specific model for the second tenant and the sixth tenant-specific model for the second tenant produced based on a second algorithm; and comparing, by the computing system, the fifth metrics and the sixth metrics to select one of the second selected tenant-specific model and the third selected tenant-specific model as a fourth selected tenant-specific model for the second tenant.

(M8) A method may be performed as described any of paragraphs (M1) through (M7), and may further involve processing, by the computing system, at least a first portion of data with the first selected tenant-specific model for the first tenant to produce third metrics, the first tenant-specific model for the first tenant and the second tenant-specific model for the first tenant produced based on a first algorithm; processing, by the computing system, at least a second portion of the data with a second selected tenant-specific model for the first tenant to produce fourth metrics, the second selected tenant-specific model for the first tenant selected from a third tenant-specific model for the first tenant and a fourth tenant-specific model for the first tenant, the third tenant-specific model for the first tenant and the fourth tenant-specific model for the first tenant produced based on a second algorithm; and comparing, by the computing system, the third metrics and the fourth metrics to select one of the first selected tenant-specific model and the second selected tenant-specific model as a third selected tenant-specific model for the first tenant.

(M9) A method may be performed as described any of paragraphs (M1) through (M8), wherein comparing the first metrics and the second metrics is performed by a model evaluation service running on the computing system.

(M10) A method may be performed as described any of paragraphs (M1) through (M9), wherein the first selected tenant-specific model is selected based on a configurable policy.

(M11) A method may be performed that involves training, by a computing system, first and second tenant-specific machine learning (ML) models for a first tenant while training, by the computing system, third and fourth tenant-specific ML models for a second tenant, the training of the first, second, third, and fourth tenant-specific ML models based on a first solution; testing, by the computing system, the first tenant-specific ML model to produce first metrics, the second tenant-specific ML model to produce second metrics, the third tenant-specific ML model to produce third metrics, and the fourth tenant-specific ML model to produce fourth metrics; comparing, by the computing system, the first metrics and the second metrics to select one of the first tenant-specific ML model and the second tenant-specific ML model as a first selected tenant-specific ML model for the first tenant, and comparing, by the computing system the third metrics and the fourth metrics to select one of the third tenant-specific ML model and the fourth tenant-specific ML model as a second selected tenant-specific ML model; and processing, by the computing system, first data with the first selected tenant-specific model to produce a first output, and processing, by the computing system, second data with the second selected tenant specific model to produce a second output.

The following paragraphs (S1) through (S11) describe examples of systems and devices that may be implemented in accordance with the present disclosure.

(S1) A computing system may comprise at least one processor and at least one computer-readable medium encoded with instructions which, when executed by the at least one processor, cause the computing system to generate a first tenant-specific model for a first tenant; generate first metrics for the first tenant-specific model; generate a second tenant-specific model for the first tenant; generate second metrics for the second tenant-specific model; and compare the first metrics and the second metrics to select one of the first tenant-specific model and the second tenant-specific model as a first selected tenant-specific model for the first tenant.

(S2) A computing system may be configured as described in paragraph (S1), wherein the at least one computer-readable medium may be encoded with additional instructions which, when executed by the at least one processor, further cause the computing system to process first data with the first selected tenant-specific model to produce a first output.

(S3) A computing system may be configured as described in paragraph (S1) or paragraph (S2), wherein the at least one computer-readable medium may be encoded with additional instructions which, when executed by the at least one processor, further cause the computing system to generate a third tenant-specific model for a second tenant; generate third metrics for the third tenant-specific model; generate a fourth tenant-specific model for the second tenant; generate fourth metrics for the fourth tenant-specific model; and compare the third metrics and the fourth metrics to select one of the third tenant-specific model and the fourth tenant-specific model as a second selected tenant-specific model for the second tenant.

(S4) A computing system may be configured as described in any of paragraph (S1) through (S3), wherein the at least one computer-readable medium may be encoded with additional instructions which, when executed by the at least one processor, further cause the computing system to process second data with the second selected tenant-specific model to produce a second output.

(S5) A computing system may be configured as described in any of paragraph (S1) through (S4), wherein the at least one computer-readable medium may be encoded with additional instructions which, when executed by the at least one processor, further cause the computing system to compare the first metrics and the second metrics while comparing the third metrics and the fourth metrics.

(S6) A computing system may be configured as described in any of paragraph (S1) through (S5), wherein the at least one computer-readable medium may be encoded with additional instructions which, when executed by the at least one processor, further cause the computing system to process first data with the first selected tenant-specific model to produce a first output while processing second data with the second selected tenant-specific model to produce a second output.

(S7) A computing system may be configured as described in any of paragraph (S1) through (S6), wherein the at least one computer-readable medium may be encoded with additional instructions which, when executed by the at least one processor, further cause the computing system to process at least a first portion of data with the second selected tenant-specific model for the second tenant to produce fifth metrics, the third tenant-specific model for the second tenant and the fourth tenant-specific model for the second tenant produced based on a first algorithm; process at least a second portion of the data with a third selected tenant-specific model for the second tenant to produce sixth metrics, the third selected tenant-specific model selected from a fifth tenant-specific model for the second tenant and a sixth tenant-specific model for the second tenant, the fifth tenant-specific model for the second tenant and the sixth tenant-specific model for the second tenant produced based on a second algorithm; and compare the fifth metrics and the sixth metrics to select one of the second selected tenant-specific model and the third selected tenant-specific model as a fourth selected tenant-specific model for the second tenant.

(S8) A computing system may be configured as described in any of paragraph (S1) through (S7), wherein the at least one computer-readable medium may be encoded with additional instructions which, when executed by the at least one processor, further cause the computing system to process at least a first portion of data with the second selected tenant-specific model for the second tenant to produce fifth metrics, the third tenant-specific model for the second tenant process at least a first portion of data with the first selected tenant-specific model for the first tenant to produce third metrics, the first tenant-specific model for the first tenant and the second tenant-specific model for the first tenant produced based on a first algorithm; process at least a second portion of the data with a second selected tenant-specific model for the first tenant to produce fourth metrics, the second selected tenant-specific model for the first tenant selected from a third tenant-specific model for the first tenant and a fourth tenant-specific model for the first tenant, the third tenant-specific model for the first tenant and the fourth tenant-specific model for the first tenant produced based on a second algorithm; and compare the third metrics and the fourth metrics to select one of the first selected tenant-specific model and the second selected tenant-specific model as a third selected tenant-specific model for the first tenant.

(S9) A computing system may be configured as described in any of paragraph (S1) through (S8), wherein comparing the first metrics and the second metrics is performed by a model evaluation service running on the computing system.

(S10) A computing system may be configured as described in any of paragraph (S1) through (S9), wherein the first selected tenant-specific model is selected based on a configurable policy.

(S11) A computing system may comprise at least one processor and at least one computer-readable medium encoded with instructions which, when executed by the at least one processor, cause the computing system to train first and second tenant-specific machine learning (ML) models for a first tenant while training third and fourth tenant-specific ML models for a second tenant, the training of the first, second, third, and fourth tenant-specific ML models based on a first solution; test the first tenant-specific ML model to produce first metrics, the second tenant-specific ML model to produce second metrics, the third tenant-specific ML model to produce third metrics, and the fourth tenant-specific ML model to produce fourth metrics; compare the first metrics and the second metrics to select one of the first tenant-specific ML model and the second tenant-specific ML model as a first selected tenant-specific ML model for the first tenant, and comparing, by the computing system the third metrics and the fourth metrics to select one of the third tenant-specific ML model and the fourth tenant-specific ML model as a second selected tenant-specific ML model; and process first data with the first selected tenant-specific model to produce a first output, and processing, by the computing system, second data with the second selected tenant specific model to produce a second output.

The following paragraphs (CRM1) through (CRM11) describe examples of computer-readable media that may be implemented in accordance with the present disclosure.

(CRM1) At least one non-transitory, computer-readable medium may be encoded with instructions which, when executed by at least one processor included in a computing system, cause the computing system to generate a first tenant-specific model for a first tenant; generate first metrics for the first tenant-specific model; generate a second tenant-specific model for the first tenant; generate second metrics for the second tenant-specific model; and compare the first metrics and the second metrics to select one of the first tenant-specific model and the second tenant-specific model as a first selected tenant-specific model for the first tenant.

(CRM2) At least one non-transitory, computer-readable medium may be configured as described in paragraph (CRM1), and may be encoded with additional instructions which, when executed by the at least one processor, further cause the computing system to process first data with the first selected tenant-specific model to produce a first output.

(CRM3) At least one non-transitory, computer-readable medium may be configured as described in paragraph (CRM1) or paragraph (CRM2), and may be encoded with additional instructions which, when executed by the at least one processor, further cause the computing system to generate a third tenant-specific model for a second tenant; generate third metrics for the third tenant-specific model; generate a fourth tenant-specific model for the second tenant; generate fourth metrics for the fourth tenant-specific model; and compare the third metrics and the fourth metrics to select one of the third tenant-specific model and the fourth tenant-specific model as a second selected tenant-specific model for the second tenant.

(CRM4) At least one non-transitory, computer-readable medium may be configured as described in any of paragraphs (CRM1) through (CRM3), and may be encoded with additional instructions which, when executed by the at least one processor, further cause the computing system to process second data with the second selected tenant-specific model to produce a second output.

(CRM5) At least one non-transitory, computer-readable medium may be configured as described in any of paragraphs (CRM1) through (CRM4), and may be encoded with additional instructions which, when executed by the at least one processor, further cause the computing system to compare the first metrics and the second metrics while comparing the third metrics and the fourth metrics.

(CRM6) At least one non-transitory, computer-readable medium may be configured as described in any of paragraphs (CRM1) through (CRM5), and may be encoded with additional instructions which, when executed by the at least one processor, further cause the computing system to process first data with the first selected tenant-specific model to produce a first output while processing second data with the second selected tenant-specific model to produce a second output.

(CRM7) At least one non-transitory, computer-readable medium may be configured as described in any of paragraphs (CRM1) through (CRM6), and may be encoded with additional instructions which, when executed by the at least one processor, further cause the computing system to process at least a first portion of data with the second selected tenant-specific model for the second tenant to produce fifth metrics, the third tenant-specific model for the second tenant and the fourth tenant-specific model for the second tenant produced based on a first algorithm; process at least a second portion of the data with a third selected tenant-specific model for the second tenant to produce sixth metrics, the third selected tenant-specific model selected from a fifth tenant-specific model for the second tenant and a sixth tenant-specific model for the second tenant, the fifth tenant-specific model for the second tenant and the sixth tenant-specific model for the second tenant produced based on a second algorithm; and compare the fifth metrics and the sixth metrics to select one of the second selected tenant-specific model and the third selected tenant-specific model as a fourth selected tenant-specific model for the second tenant.

(CRM8) At least one non-transitory, computer-readable medium may be configured as described in any of paragraphs (CRM1) through (CRM7), and may be encoded with additional instructions which, when executed by the at least one processor, further cause the computing system to process at least a first portion of data with the second selected tenant-specific model for the second tenant to produce fifth metrics, the third tenant-specific model for the second tenant process at least a first portion of data with the first selected tenant-specific model for the first tenant to produce third metrics, the first tenant-specific model for the first tenant and the second tenant-specific model for the first tenant produced based on a first algorithm; process at least a second portion of the data with a second selected tenant-specific model for the first tenant to produce fourth metrics, the second selected tenant-specific model for the first tenant selected from a third tenant-specific model for the first tenant and a fourth tenant-specific model for the first tenant, the third tenant-specific model for the first tenant and the fourth tenant-specific model for the first tenant produced based on a second algorithm; and compare the third metrics and the fourth metrics to select one of the first selected tenant-specific model and the second selected tenant-specific model as a third selected tenant-specific model for the first tenant.

(CRM9) At least one non-transitory, computer-readable medium may be configured as described in any of paragraphs (CRM1) through (CRM8), wherein comparing the first metrics and the second metrics is performed by a model evaluation service running on the computing system.

(CRM10) At least one non-transitory, computer-readable medium may be configured as described in any of paragraphs (CRM1) through (CRM9), wherein the first selected tenant-specific model is selected based on a configurable policy.

(CRM11) At least one non-transitory, computer-readable medium may be encoded with instructions which, when executed by at least one processor included in a computing system, cause the computing system to train first and second tenant-specific machine learning (ML) models for a first tenant while training third and fourth tenant-specific ML models for a second tenant, the training of the first, second, third, and fourth tenant-specific ML models based on a first solution; test the first tenant-specific ML model to produce first metrics, the second tenant-specific ML model to produce second metrics, the third tenant-specific ML model to produce third metrics, and the fourth tenant-specific ML model to produce fourth metrics; compare the first metrics and the second metrics to select one of the first tenant-specific ML model and the second tenant-specific ML model as a first selected tenant-specific ML model for the first tenant, and comparing, by the computing system the third metrics and the fourth metrics to select one of the third tenant-specific ML model and the fourth tenant-specific ML model as a second selected tenant-specific ML model; and process first data with the first selected tenant-specific model to produce a first output, and processing, by the computing system, second data with the second selected tenant specific model to produce a second out.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
generating, by a computing system, a first tenant-specific model for a first tenant;
generating, by the computing system, first metrics for the first tenant-specific model;
generating, by the computing system, a second tenant-specific model for the first tenant;
generating, by the computing system, second metrics for the second tenant-specific model; and
comparing, by the computing system, the first metrics and the second metrics to select one of the first tenant-specific model and the second tenant-specific model as a first selected tenant-specific model for the first tenant.

2. The method of claim 1, further comprising:
processing, by the computing system, first data with the first selected tenant-specific model to produce a first output.

3. The method of claim 1, further comprising:
generating, by a computing system, a third tenant-specific model for a second tenant;
generating, by the computing system, third metrics for the third tenant-specific model;
generating, by the computing system, a fourth tenant-specific model for the second tenant;
generating, by the computing system, fourth metrics for the fourth tenant-specific model; and
comparing, by the computing system, the third metrics and the fourth metrics to select one of the third tenant-specific model and the fourth tenant-specific model as a second selected tenant-specific model for the second tenant.

4. The method of claim 3, further comprising:
processing, by the computing system, second data with the second selected tenant-specific model to produce a second output.

5. The method of claim 3, further comprising:
comparing, by the computing system, the first metrics and the second metrics while comparing the third metrics and the fourth metrics.

6. The method of claim 3, further comprising:
processing, by the computing system, first data with the first selected tenant-specific model to produce a first output while processing second data with the second selected tenant-specific model to produce a second output.

7. The method of claim 3, further comprising:
processing, by the computing system, at least a first portion of data with the second selected tenant-specific model for the second tenant to produce fifth metrics, the third tenant-specific model for the second tenant and the fourth tenant-specific model for the second tenant produced based on a first algorithm;
processing, by the computing system, at least a second portion of the data with a third selected tenant-specific model for the second tenant to produce sixth metrics, the third selected tenant-specific model selected from a fifth tenant-specific model for the second tenant and a sixth tenant-specific model for the second tenant, the fifth tenant-specific model for the second tenant and the sixth tenant-specific model for the second tenant produced based on a second algorithm; and
comparing, by the computing system, the fifth metrics and the sixth metrics to select one of the second selected tenant-specific model and the third selected tenant-specific model as a fourth selected tenant-specific model for the second tenant.

8. The method of claim 1, further comprising:
processing, by the computing system, at least a first portion of data with the first selected tenant-specific model for the first tenant to produce third metrics, the first tenant-specific model for the first tenant and the second tenant-specific model for the first tenant produced based on a first algorithm;
processing, by the computing system, at least a second portion of the data with a second selected tenant-specific model for the first tenant to produce fourth metrics, the second selected tenant-specific model for the first tenant selected from a third tenant-specific model for the first tenant and a fourth tenant-specific model for the first tenant, the third tenant-specific model for the first tenant and the fourth tenant-specific model for the first tenant produced based on a second algorithm; and
comparing, by the computing system, the third metrics and the fourth metrics to select one of the first selected tenant-specific model and the second selected tenant-specific model as a third selected tenant-specific model for the first tenant.

9. The method of claim 1, wherein comparing the first metrics and the second metrics is performed by a model evaluation service running on the computing system.

10. The method of claim 1, wherein the first selected tenant-specific model is selected based on a configurable policy.

11. A computing system, comprising:
at least one processor; and
at least one computer-readable medium encoded with instructions which, when executed by the at least one processor, cause the computing system to:
generate a first tenant-specific model for a first tenant;
generate first metrics for the first tenant-specific model;
generate a second tenant-specific model for the first tenant;
generate second metrics for the second tenant-specific model; and
compare the first metrics and the second metrics to select one of the first tenant-specific model and the second tenant-specific model as a first selected tenant-specific model for the first tenant.

12. The computing system of claim 11, wherein the at least one computer-readable medium is further encoded with additional instructions which, when executed by the at least one processor, further cause the computing system to:
process first data with the first selected tenant-specific model to produce a first output.

13. The computing system of claim 11, wherein the at least one computer-readable medium is further encoded with additional instructions which, when executed by the at least one processor, further cause the computing system to:
generate a third tenant-specific model for a second tenant;
generate third metrics for the third tenant-specific model;
generate a fourth tenant-specific model for the second tenant;
generate fourth metrics for the fourth tenant-specific model; and
compare the third metrics and the fourth metrics to select one of the third tenant-specific model and the fourth tenant-specific model as a second selected tenant-specific model for the second tenant.

14. The computing system of claim 13, wherein the at least one computer-readable medium is further encoded with additional instructions which, when executed by the at least one processor, further cause the computing system to:
process second data with the second selected tenant-specific model to produce a second output.

15. The computing system of claim 13, wherein the at least one computer-readable medium is further encoded with additional instructions which, when executed by the at least one processor, further cause the computing system to:
compare the first metrics and the second metrics while comparing the third metrics and the fourth metrics.

16. The computing system of claim 13, wherein the at least one computer-readable medium is further encoded with additional instructions which, when executed by the at least one processor, further cause the computing system to:
process first data with the first selected tenant-specific model to produce a first output while processing second data with the second selected tenant-specific model to produce a second output.

17. The computing system of claim 13, wherein the at least one computer-readable medium is further encoded with additional instructions which, when executed by the at least one processor, further cause the computing system to:
process at least a first portion of data with the second selected tenant-specific model for the second tenant to produce fifth metrics, the third tenant-specific model for the second tenant and the fourth tenant-specific model for the second tenant produced based on a first algorithm;
process at least a second portion of the data with a third selected tenant-specific model for the second tenant to produce sixth metrics, the third selected tenant-specific model selected from a fifth tenant-specific model for the second tenant and a sixth tenant-specific model for the second tenant, the fifth tenant-specific model for the second tenant and the sixth tenant-specific model for the second tenant produced based on a second algorithm; and
compare the fifth metrics and the sixth metrics to select one of the second selected tenant-specific model and the third selected tenant-specific model as a fourth selected tenant-specific model for the second tenant.

18. The computing system of claim 11, wherein the at least one computer-readable medium is further encoded with additional instructions which, when executed by the at least one processor, further cause the computing system to:
process at least a first portion of data with the first selected tenant-specific model for the first tenant to produce third metrics, the first tenant-specific model for the first tenant and the second tenant-specific model for the first tenant produced based on a first algorithm;
process at least a second portion of the data with a second selected tenant-specific model for the first tenant to produce fourth metrics, the second selected tenant-specific model for the first tenant selected from a third tenant-specific model for the first tenant and a fourth tenant-specific model for the first tenant, the third tenant-specific model for the first tenant and the fourth tenant-specific model for the first tenant produced based on a second algorithm; and
compare the third metrics and the fourth metrics to select one of the first selected tenant-specific model and the second selected tenant-specific model as a third selected tenant-specific model for the first tenant.

19. The computing system of claim 11, wherein comparing the first metrics and the second metrics is performed by a model evaluation service running on the computing system.

20. A method, comprising:
training, by a computing system, first and second tenant-specific machine learning (ML) models for a first tenant while training, by the computing system, third and fourth tenant-specific ML models for a second tenant, the training of the first, second, third, and fourth tenant-specific ML models based on a first solution;
testing, by the computing system, the first tenant-specific ML model to produce first metrics, the second tenant-specific ML model to produce second metrics, the third tenant-specific ML model to produce third metrics, and the fourth tenant-specific ML model to produce fourth metrics;
comparing, by the computing system, the first metrics and the second metrics to select one of the first tenant-specific ML model and the second tenant-specific ML model as a first selected tenant-specific ML model for the first tenant, and comparing, by the computing system the third metrics and the fourth metrics to select one of the third tenant-specific ML model and the fourth tenant-specific ML model as a second selected tenant-specific ML model; and
processing, by the computing system, first data with the first selected tenant-specific model to produce a first output, and processing, by the computing system, second data with the second selected tenant specific model to produce a second output.
